(19) United States
(12) Patent Application Publication
(10) Pub. No.: US 2025/0370410 A1
(43) Pub. Date: Dec. 4, 2025

(54) METHOD AND APPARATUS FOR HOLOGRAPHIC IMAGING

(71) Applicant: Hazen Paper Company, Holyoke, MA (US)

(72) Inventors: John Hazen, South Hadley, MA (US); Larry Hoague, Feeding Hills, MA (US)

(73) Assignee: Hazen Paper Company, Holyoke, MA (US)

(21) Appl. No.: 19/223,983

(22) Filed: May 30, 2025

Related U.S. Application Data
(60) Provisional application No. 63/654,212, filed on May 31, 2024.

(51) Int. Cl. G03H 1/22

(52) U.S. Cl. CPC G03H 1/2202; G03H 2001/2242; G03H 2240/51

(57) ABSTRACT

A method of forming two distinct images in a substrate includes controlling a high-energy beam to form a profile ridge in the substrate, and thereafter defining a first set of features on a first side of the profile ridge, the first set of features representing a first distinct image when the substrate is perceived by an observer from a first angle, as well as defining a second set of features on a second side of the profile ridge, the second set of features representing a second distinct image when the substrate is perceived by an observer from a second angle. Both the first set of features and the second set of features are positioned in a common vertical substrate space of the substrate.

### CROSS-REFERENCE TO RELATED APPLICATIONS

This application claims the benefit of U.S. Provisional Application Ser. No. 63/654,212, filed on May 31, 2024, which is herein incorporated by reference in its entirety.

### FIELD OF THE INVENTION

The present invention concerns, generally, a method and apparatus for holographic imaging, and more especially, to a method and apparatus of holographic imaging that utilizes a high energy beam to form appropriate profiles in a substrate material, thus permitting the realization of two or more distinct images when viewed at two or more respective and distinct angles, all in the same vertical substrate space, and in the same substrate layer.

### BACKGROUND OF THE INVENTION

Generally speaking, holographic imagery depends on the ability to project distinct images from a substrate, in different viewing directions, such that an observer from a particular angle and distance from the substrate would see only one of these distinct images.

Thus, it is known that holographic imaging showing two or more distinct images (either separate images altogether, or to effect a ‘movement’ of the same general image) can be produced by lenticular printing. This process takes a batch of images and prints alternating strips of each image on the back of, e.g., a transparent plastic sheet. The plastic sheet has a series of curved ridges. Each curved ridge is a lenticule. When light passes through the plastic sheet, it is reflected from smooth white paper under the plastic sheet. The returning light passes through the image strips printed on the plastic sheet. The lenticule is made in such a way that it refracts the returning light at a specific angle and magnifies the image. The strips are aligned so that all of the strips for a particular image are refracted to the same point. Because of the refraction and magnification, what you see is a single, complete image. As you change the angle of the substrate in relation to your line of sight, you see the different image strips as a series of complete images. by forming lenticular lens, and splitting each image into separate strips, aligned with each successive lenticular, such that viewing the substrate in one angle, you get one distinct image, and a different image from a different viewing angle. Such a system is shown in U.S. Pat. No. 5,424,553 and herein incorporated by reference in its entirety.

In combination with a lenticular lens, or alone, it is also known to form separate profiles in a substrate via the physical embossing of the substrate, whereby each profile is only viewable from a particular angle with respect to the substrate. This can be done by embossing differing profiles, each having their own optical parameters and thus producing differing and distinct images, adjacent to one another and in the same substrate layer (see, U.S. Pat. No. 10,252,563; FIGS. 1F-1, 1F-2, 1H and 1I; herein incorporated by reference).

Thus, there exists a longstanding need in the art for providing a method and apparatus of holographic imaging that utilizes a high energy beam to form appropriate profiles in a substrate material, thus permitting the realization of two or more distinct images when viewed at two or more respective and distinct angles, all in the same vertical substrate space, and in the same substrate layer.

### SUMMARY OF THE INVENTION

It is therefore one important aspect of the present invention to provide a method and apparatus of holographic imaging.

It is another important aspect of the present invention is to provide a method and apparatus of holographic imaging that utilizes a high energy beam to form appropriate profiles in a substrate material.

It is another important aspect of the present invention is to provide a method and apparatus of holographic imaging that utilizes a high energy beam to form two differing profiles in a substrate material.

It is another important aspect of the present invention is to provide a method and apparatus of holographic imaging that utilizes a high energy beam to form two differing profiles in a substrate material, each of the differing profiles being formed in the same substrate layer.

It is another important aspect of the present invention is to provide a method and apparatus of holographic imaging that utilizes a high energy beam to form two differing profiles in a substrate material, each of the differing profiles being formed in the same vertical substrate space.

Further features of the present invention and advantages thereof will become apparent from the following detailed description of exemplary embodiments, with reference to the adjoining drawings.

### BRIEF DESCRIPTION OF THE DRAWINGS

The invention will be better understood making reference to the drawings attached, in which:

FIG. 1 illustrates one possible method of producing a holographic composite, according to known prior art.

FIG. 2 illustrates one embodiment of the present invention, in which two sets of images are formed on opposing sides of a profile ridge.

FIG. 3 illustrates one schematic representation of a high energy beam apparatus capable of forming profile ridges in a substrate.

### DETAILED DESCRIPTION OF THE INVENTION

Making now reference in particular to the previously mentioned figures, the present invention will be now described in detail.

The present invention proposes a method and apparatus of holographic imaging that utilizes a high energy beam to form, e.g., two differing sets of profiles in a substrate material, each of the differing set of profiles being formed in the same substrate layer and in the same vertical substrate space, and representing, respectively, two differing images to the eye of an observer when viewed from two distinct angles.

The proposed method and apparatus involves the creation of a holographic composite that itself may be comprised of laminates, films, or layers including a plurality of optical features configured such that an observer viewing the article from a first direction perceives a first set of distinct images. while perceiving a second set of distinct images when viewing the article from a second direction. Once illuminated by reflected/refracted light, the holographic composite is capable of reproducing each of the two images, when viewed by an observer in two separate and differing angles. It will be appreciated that the surface normals of the 3D object to be imaged may be mimicked as surface reliefs/profiles on the holographic composite.

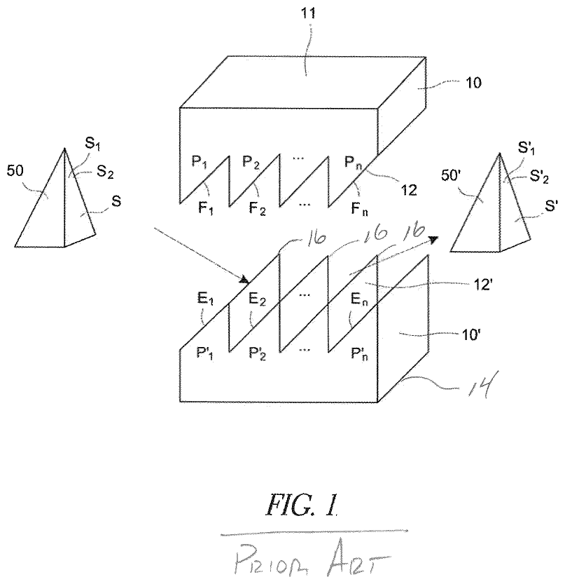

Prior art FIG. 1 illustrates one possible method of producing a holographic composite. As shown in prior art FIG. 1, and as discussed in U.S. Pat. No. 10,252,563 (herein incorporated by reference in its entirety), a master 10 is utilized and can include a first surface 11 and a second surface 12 opposite the first surface 11. As shown in FIG. 1, the second surface 12 can include a plurality of portions P₁, P₂, . . . Pₙ. Each portion P. can correspond to a plurality of portions P′₁, P′₂, . . . P′ₙ on the holographic composite 10′. The plurality of portions P′₁, P′₂, . . . P′ₙ on the optical product 10′ can also be referred to as a cell, pixel, or a tile.

Moreover, each portion P. of the master 10 (and each portion P′ₙ of the holographic composite 10′) can correspond to a point S₁, S₂, . . . Sₙ on a surface S of the 3D object 50. Each portion P. can include features F₁, F₂, . . . Fₙ corresponding to elements E₁, E₂, . . . Eₙ, e.g., non-holographic elements, on the holographic composite 10′. A gradient (e.g., slope) in the features F₁, F₂, . . . Fₙ can correlate to an inclination (e.g., slope) of the surface S of the 3D object 50 at the corresponding point S₁, S₂, . . . Sₙ. In addition, an orientation of the features F₁, F₂, . . . Fₙ can correlate to an orientation of the surface S of the 3D object 50 at the corresponding point S₁, S₂, . . . Sₙ. Accordingly, the holographic composite 10′ fabricated using the example master 10 can be configured, when illuminated, to reproduce by reflected (or refracted) light, a 3D image 50′ (e.g., an image that appears 3D) of at least a part of a 3D object 50. The image can be observed by the naked eye and under various lighting conditions (e.g., specular, diffuse, and/or low light conditions).

The holographic composite 10′ can be used on a variety of products to reproduce a 3D image 50′ of at least a part of a 3D object 50. For example, the holographic composite 10′ can be placed on decorative signs, advertisements, labels (e.g., self-adhesive labels), packaging (e.g., consumer paper board packaging and/or flexible packaging), consumer goods, collectible cards (e.g., baseball cards), etc. The holographic composite 10′ can also be advantageously used for authenticity and security applications. For example, the holographic composite 10′ can be placed on currency (e.g., a banknote), credit cards, debit cards, passports, driver's licenses, identification cards, documents, tamper evident containers and packaging, bottles of pharmaceuticals, etc.

While the teachings of U.S. Pat. No. 10,252,563 provide one method of forming a holographic composite 10′ in a substrate 14, it will be readily appreciated that such a method utilizes essentially only one side of a series of profile ridges 16 formed in the substrate 14 (i.e., portions P₁, P₂, . . . Pₙ,) to define the optical parameters (i.e., E₁, E₂ . . . . Eₙ, of a first image. In accordance with this known method, a separate set of profile ridges, defining optical parameters of a second image, must also be formed in the substrate 14, but in a different vertical substrate space (i.e., in the same substrate layer, but located adjacent to the first set of profiles defining the first image).

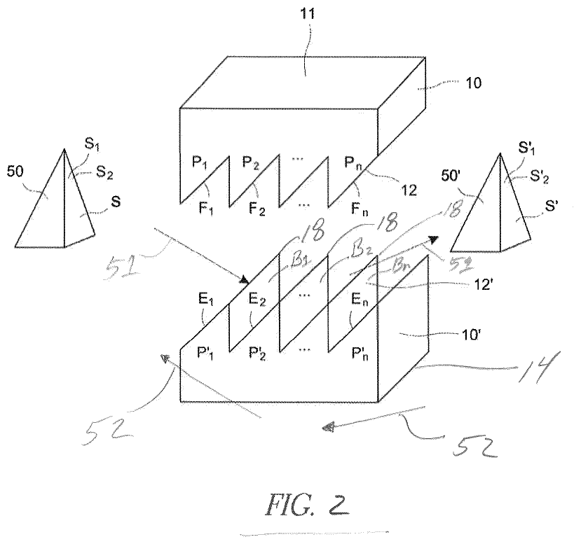

In contrast, FIG. 2 illustrates one embodiment of the present invention, in which profile ridges 18 are formed in a suitable substrate 14, and in which a second set of image features (i.e., B₁, B₂, . . . Bₙ) are formed on the opposing sides of profile ridges 18. In this manner, when an observer views a suitably formed substrate 14 in a first direction, 51, a first image can be perceived, yet when the same substrate 14 is viewed in a second direction, 52, a second, differing image may be perceived.

In this manner, the use of alternate sides of a formed profile ridge within a substrate 14 permits the realization of two or more distinct images when viewed at two or more respective and distinct angles, all in the same vertical substrate space, and in the same substrate layer.

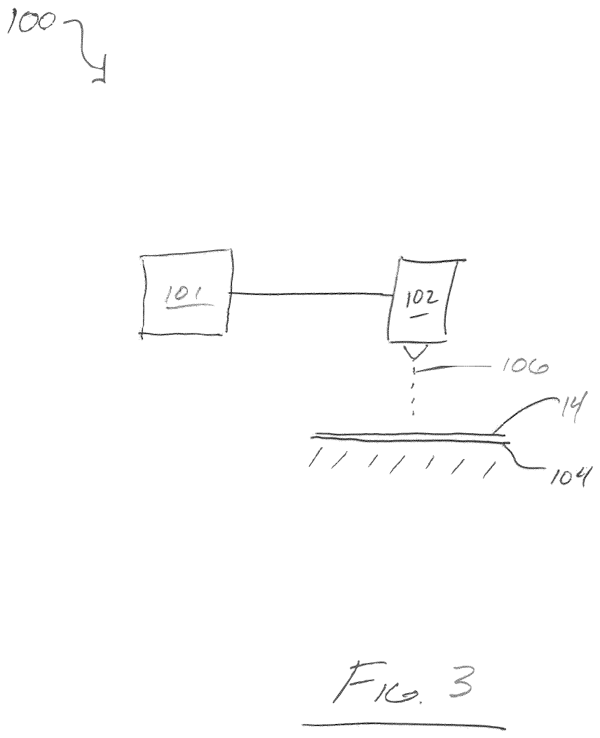

FIG. 3 illustrates one schematic representation of a high energy beam apparatus 100 capable of forming profile ridges 18 in a substrate 14. As shown in FIG. 3, a computer control console 101 is utilized to communicate design and movement parameters (including but not limited to beam intensity and direction), to an integrated high-energy beam generator 102.

A high-energy beam 106 issued by the high-energy beam generator 102 is then utilized, under control of the computer control console 101, to form suitable profiles 18 in the substrate 14, as the substrate 14 is supported by a platen 104 (which may be movable, or stationary, without departing from the broader aspects of the present invention).

As will be appreciated, the present invention contemplates articles including laminates, films, or layers including a plurality of optical features configured such that a viewer viewing the article from a first direction perceives a first set of distinct images and perceives a second set of distinct images when viewing the article from a second direction. At the first direction, the viewer does not perceive the second set of distinct images. At the second direction, the viewer does not perceive the first set of distinct images. There may be little to no overlap between the first and the second set of images. The first and the second set of images can include one or more patterns, one or more characters, one or more objects, one or more numbers, one or more graphics, and/or one or more letters. The laminates, films, or layers can be reflective or transmissive. In reflective embodiments, incident light reflected from the plurality of optical features can have varying levels of brightness based on the viewing direction which results in the perception of depth in the different distinct images.

The present invention can be advantageously manufactured on a large industrial scale. The laminates, films, or layers including optical features that can produce different distinct images when viewed from different directions can be manufactured on polymeric substrates, such as, for example, polyethylene terephthalate (PET), oriented polypropylene (OPP), low density polyethylene (LDPE), linear low density polyethylene (LLDPE), polypropylene (PP), polyvinyl chloride (PVC), polycarbonate (PC) or any other type of plastic film. In various embodiments, the polymeric substrate can be clear. The polymeric substrates can have a thickness less than or equal to 300 microns (e.g., less than or equal to 250 microns, less than or equal to 200 microns, less than or equal to 150 microns, less than or equal to 100 microns, less than or equal to 50 microns, less than or equal to 25 microns, less than or equal to 15 microns, etc.) and/or from 10 microns to 300 microns, or any range within this range (e.g., from 10 microns to 250 microns, from 12.5 microns to 250 microns, from 12.5 microns to 200 microns, from 10 microns to 25 microns, from 10 microns to 15 microns, etc.). Polymeric substrates including laminates, films, or layers comprising optical features that can produce different distinct images when viewed from different directions having such a thickness can be formed into security threads that can be incorporated into a banknote which has similar thickness.

The first and the second viewing directions can be oriented (e.g., tilted and/or rotated) with respect to each other by an angle from 10 degrees to 60 degrees. For example, in reflective embodiments different distinct non-overlapping images can be perceived when the laminate, film or layer including optical features that can produce different distinct images when viewed from different directions is tilted about an axis in the plane of the laminate, film or layer by an angle less than or equal to 20 degrees. As another example, in transmissive embodiments different distinct non-overlapping images can be perceived when the laminate, film or layer including optical features that can produce different distinct images when viewed from different directions is rotated about an axis perpendicular to the plane of the laminate, film or layer by an angle less than or equal to 45 degrees.

In reflective embodiments, the plurality of optical features that can produce different distinct images when viewed from different directions can be coated with a reflective material, such as, for example, aluminum, silver, copper or some other reflective metal. In embodiments where the plurality of optical features are coated with a reflective metal, the thickness of the reflective metal can be greater than or equal to 45 num (e.g., 50 nm, 55 nm, 60 nm, etc.) and/or be in a range from 45 nm to 100 nm, or any range within this range (e.g., from 45 nm to 85 nm, from 45 nm to 75 nm, from 50 nm to 85 nm, etc.) such that the laminate, film or layer is opaque. Alternately, the thickness of the reflective metal can be less than 45 nm (e.g., 10 nm, 15 nm, 20 nm, 25 nm, etc.) and/or be in a range from 10 nm to 44.9 nm, or any range within this range (e.g., from 10 nm to 40 nm, from 10 nm to 35 nm, from 10 nm to 30 nm, etc.) such that the laminate, film or layer is semi-transparent.

Additionally, the plurality of the optical features and/or the reflective material coating the plurality of the optical features can be covered with a protective coating (e.g., an organic resin coat) to protect the plurality of the optical features and/or the reflective material coating the plurality of the optical features from corrosion from acidic or basic solutions or organic solvents such as gasoline and ethyl acetate or butyl acetate. The plurality of optical features can include relief features disposed on the surface of the polymeric substrate. In various embodiments, the plurality of optical features can include grooves or facets disposed on the surface of the polymeric substrate. In various embodiments, the orientation, slope/gradient and other physical attributes of the optical features can be determined from the images that are desired to be reproduced. The images can be in the form of a dot matrix or a 3D image. The laminates, films and layers including the plurality of optical features that can produce different distinct images when viewed from different directions can be integrated with one or more lenses (e.g., a curved lens or a Fresnel lens or an array of lenses such as a lenticular lens). In such embodiments, the focal length of the lens can be approximately equal to the thickness of polymeric substrate. In some embodiments, the optical features can be incorporated with one or more prisms or mirrors.

Although the invention has been described in relation to specific embodiments it is obvious that other embodiments are included within the object and the scope of the invention, being this invention only limited by the claims that follow.

What is claimed is:

1. A method for realizing two distinct images in a substrate, such that each of said two distinct images can be respectively viewed at two or more respective and distinct angles, said method comprising the steps of:
controlling a high-energy beam to form profile ridges in said substrate;
defining a first set of features on a first side of said profile ridges, said first set of features representing a first distinct image perceivable by an observer from a first of said two or more respective and distinct angles;
defining a second set of features on a second side of said profile ridges, said second set of features representing a second distinct image perceivable by said observer from a second of said two or more respective and distinct angles; and
positioning said first set of features and said second set of features in a common vertical substrate space of said substrate.

2. The method for realizing two distinct images in a substrate, such that each of said two distinct images can be respectively viewed at two or more respective and distinct angles according to claim 1, said method further comprising the steps of:
defining said first distinct image and said second distinct image to be rotated between 20 to 60 degrees from one another.

3. The method for realizing two distinct images in a substrate, such that each of said two distinct images can be respectively viewed at two or more respective and distinct angles according to claim 1, said method further comprising the steps of:
defining said first distinct image and said second distinct image to be rotated by an angle less than or equal to 45 degrees from one another.

4. A method of forming two distinct images in a substrate, such that each of said two distinct images can be selectively viewed at distinct angles, said method comprising the steps of:
controlling a high-energy beam to form a profile ridge in said substrate;
defining a first set of features on a first side of said profile ridge, said first set of features representing a first distinct image perceivable by an observer from a first of said distinct angles;
defining a second set of features on a second side of said profile ridge, said second set of features representing a second distinct image perceivable by said observer from a second of said distinct angles; and
positioning said first set of features and said second set of features in a common vertical substrate space of said substrate.

5. The method for realizing two distinct images in a substrate, such that each of said two distinct images can be respectively viewed at two or more respective and distinct angles according to claim 4, said method further comprising the steps of:
defining said first distinct image and said second distinct image to be rotated between 20 to 60 degrees from one another.

6. The method for realizing two distinct images in a substrate, such that each of said two distinct images can be respectively viewed at two or more respective and distinct angles according to claim 4, said method further comprising the steps of:
defining said first distinct image and said second distinct image to be rotated by an angle less than or equal to 45 degrees from one another.

7. A method of forming two distinct images in a substrate, said method comprising the steps of:
controlling a high-energy beam to form a profile ridge in said substrate;
defining a first set of features on a first side of said profile ridge, said first set of features representing a first distinct image when said substrate is perceived by an observer from a first angle;
defining a second set of features on a second side of said profile ridge, said second set of features representing a second distinct image when said substrate is perceived by an observer from a second angle; and
positioning said first set of features and said second set of features in a common vertical substrate space of said substrate.

8. The method for realizing two distinct images in a substrate according to claim 7, said method further comprising the steps of:
controlling said high energy beam to define said first distinct image and said second distinct image so as to be oriented 20 to 60 degrees differently from one another.

9. The method for realizing two distinct images in a substrate according to claim 7, said method further comprising the steps of:
controlling said high energy beam to define said first distinct image and said second distinct image to be rotated by an angle less than or equal to 45 degrees from one another.
